(19) United States
(12) Patent Application Publication
(10) Pub. No.: US 2026/0116232 A1
(43) Pub. Date: Apr. 30, 2026

(54) AUTONOMOUS NAVIGATION TO CHARGING INTERFACE USING SLAM AND SECONDARY EFFECTS

(71) Applicant: Oshkosh Corporation, Oshkosh, WI (US)

(72) Inventor: Guido Ritelli, Oshkosh, WI (US)

(21) Appl. No.: 19/086,637

(22) Filed: Mar. 21, 2025

Related U.S. Application Data
(60) Provisional application No. 63/712,649, filed on Oct. 28, 2024.
(60) Provisional application No. 63/712,644, filed on Oct. 28, 2024.

(51) Int. Cl. B60L 53/39; B60L 53/122; B60L 53/62; E01H 1/00

(52) U.S. Cl. CPC B60L 53/39; B60L 53/122; B60L 53/62; E01H 1/00

(57) ABSTRACT

A platform for charging a vehicle includes a charging apparatus. The charging apparatus includes an energy source, a first charging interface, and a first plurality of alignment members. The first charging interface is operatively coupled to the energy source and configured to wirelessly transmit energy to an energy storage device of the vehicle via a second charging interface of the vehicle. The first plurality of alignment members are configured to align the first charging interface relative to the second charging interface.

### CROSS-REFERENCE TO RELATED PATENT APPLICATIONS

This application claims the benefit of and priority to U.S. Provisional Application No. 63/712,649, filed on Oct. 28, 2024, and U.S. Provisional Application No. 63/712,644, filed on Oct. 28, 2024, the entire disclosure of which is hereby incorporated by reference herein.

### BACKGROUND

The present disclosure relates generally to vehicles. More specifically, the present disclosure relates to charging vehicles that may be utilized at a jobsite or vocational vehicles.

Vehicles are utilized to transport personnel and equipment between different areas. Vehicles may utilize a drivetrain that consumes power from an onboard energy storage device to operate one or more tractive elements to propel the vehicle. The vehicles may include one or more sensors that facilitate navigation or other operation of the vehicles.

### SUMMARY

At least one embodiment relates to a platform for charging a vehicle including a charging apparatus. The charging apparatus includes an energy source, a first charging interface, and a first plurality of alignment members. The first charging interface is operatively coupled to the energy source and configured to wirelessly transmit energy to an energy storage device of the vehicle via a second charging interface of the vehicle. The first plurality of alignment members are configured to align the first charging interface relative to the second charging interface.

At least one embodiment relates to a charging system comprising a vehicle and a platform. The vehicle an energy storage device and a first charging apparatus. The first charging apparatus includes a first charging interface operatively coupled to the energy storage device configured to wirelessly receive energy from an energy source, and a first plurality of magnets. The platform comprises a second charging apparatus. The second charging apparatus includes the energy source, a second charging interface operatively coupled to the energy source configured to transmit energy to the energy storage device, and a second plurality of magnets. At least one of the first charging apparatus or the second charging apparatus includes a spring assembly configured to allow an attraction force between the first plurality of magnets and the second plurality of magnets to align the first charging interface relative to the second charging interface.

At least one embodiment relates to a charging system comprising a vehicle and a platform. The vehicle an energy storage device and a first charging apparatus. The first charging apparatus a first charging interface and a guide. The first charging interface is operatively coupled to the energy storage device configured to wirelessly receive energy from an energy source. The guide is fixedly coupled to an underside of the vehicle. The platform includes a second charging apparatus. The second charging apparatus includes the energy source, a second charging interface, and a first plurality of roller bearings. The second charging interface is operatively coupled to the energy source and configured to transmit energy to the energy storage device. The first plurality of roller bearings project vertically from a top surface of the platform. The first plurality of roller bearings is configured to engage the guide as the vehicle moves onto the platform to align the first charging interface relative to the second charging interface.

This summary is illustrative only and is not intended to be in any way limiting. Other aspects, inventive features, and advantages of the devices or processes described herein will become apparent in the detailed description set forth herein, taken in conjunction with the accompanying figures, wherein like reference numerals refer to like elements.

### BRIEF DESCRIPTION OF THE FIGURES

The disclosure will become more fully understood from the following detailed description, taken in conjunction with the accompanying figures, wherein like reference numerals refer to like elements, in which:

FIG. 1 is a block diagram of a vehicle, according to an exemplary embodiment.

FIG. 2 is a block diagram of a system including the vehicle of FIG. 1, according to an exemplary embodiment.

FIG. 3 is a block diagram of a system including the vehicle of FIG. 1 and a platform for wireless charging, according to an exemplary embodiment.

FIG. 4 is a top view of the vehicle of FIG. 1 moving towards the second charging interface, according to an exemplary embodiment.

FIG. 5 is a top view of the vehicle of FIG. 1 moving towards the second charging interface, according to an exemplary embodiment.

FIG. 6 is a top view of the second charging interface, including actuators, according to an exemplary embodiment.

FIG. 7 is a perspective view of the second charging interface, according to an exemplary embodiment.

FIG. 8A is a top view of the vehicle of FIG. 1 moving towards the second charging interface, according to an exemplary embodiment.

FIG. 8B is a top view of the vehicle of FIG. 1 moving towards the second charging interface, according to an exemplary embodiment.

FIG. 8C is a top view of the vehicle of FIG. 1 on the platform when the first charging interface and the second charging interface are aligned, according to an exemplary embodiment.

FIG. 9A is a top view of the vehicle of FIG. 1 moving away from the second charging interface, according to an exemplary embodiment.

FIG. 9B is a top view of the vehicle of FIG. 1 moving away from the second charging interface, according to an exemplary embodiment.

FIG. 10 is a perspective view of the vehicle of FIG. 1 aligned with the wireless charging pad, according to an exemplary embodiment.

FIG. 11 is a top view of the vehicle of FIG. 1 aligning with the charging station area using SLAM, according to an exemplary embodiment.

FIG. 12 is a top view of the vehicle of FIG. 1 aligning with the charging station area using SLAM, according to an exemplary embodiment.

### DETAILED DESCRIPTION

Before turning to the FIGURES, which illustrate certain exemplary embodiments in detail, it should be understood that the present disclosure is not limited to the details or methodology set forth in the description or illustrated in the figures. It should also be understood that the terminology used herein is for the purpose of description only and should not be regarded as limiting.

Referring generally to the FIGURES, to a charging system for a vehicle including a vehicle and a charging station. An induction coil is configured to receive electricity from an energy source and generate a magnetic field that extends upwardly, through the upper surface of a platform within the charging station. In some embodiments, the vehicle and the charging station include alignment members, such as roller bearings or magnets for self-alignment. The alignment members adjust the position of a charging pad on the vehicle (e.g., the vehicle component that receives the magnetic field) and/or the position of the charging pad on the charging station (e.g., the charging station component that transmits the magnetic field). The alignment members can adjust the charging pads to be positioned for optimal energy transfer. Self-alignment can be beneficial for autonomous vehicle navigation such that it allows for passive alignment of the charging components. Therefore, the vehicles need not drive back and forth (or otherwise readjust the vehicle) to attempt to land over the charging pad. Without self-alignment it may be difficult for vehicles to determine when they are properly positioned, as the charging pads are disposed under the vehicle. Therefore, self-alignment promotes efficiency of the charging process. as well as optimizes the efficiency of the charge transfer.

In some embodiments, the vehicle additionally or alternatively includes sensors (such as LIDAR sensors) for simultaneous localization and mapping (SLAM) of environmental features surrounding the charging station. Using a SLAM algorithm utilizes the natural environment features to localize the charging station by identifying features unique to the specific location to use for precise localization. Additionally and/or alternatively, the charging station can be configured such that it is easily identifiable by SLAM, thereby eliminating the need to detect other environmental features. Utilization of SLAM can be beneficial for autonomous vehicle navigation such that it can provide enhanced obstacle avoidance when navigating a vehicle to a desired location.

### Vehicle

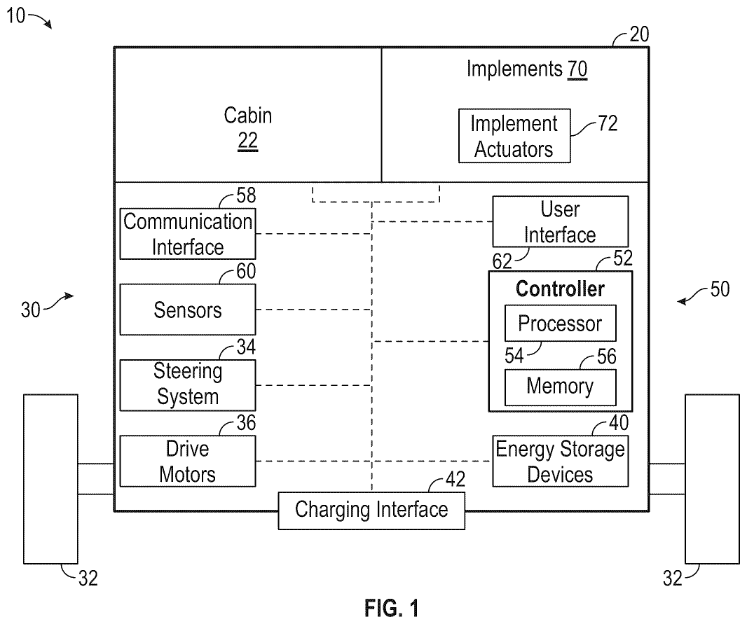

Referring to FIG. 1, a vehicle (e.g., a vocational vehicle, a work machine, etc.), is shown as vehicle 10 according to an exemplary embodiment. By way of example, the vehicle 10 may be a lift device, such as a boom lift, a telehandler, an aerial work platform, a scissor lift, a vertical lift, a compact crawler boom, a forklift, a crane, a bucket truck, or another type of lift device. In other embodiments, the vehicle 10 is another type of vehicle or work machine, such as a military vehicle, a cement truck, a refuse vehicle, a fire apparatus (e.g., a fire truck including a deployable ladder, an aircraft rescue and firefighting truck, etc.), a tow truck, a robot, or another type of vehicle or work machine.

The vehicle 10 includes a frame assembly, housing, or chassis, shown as chassis 20, that supports the other components of the vehicle 10. The chassis 20 may include one or more components (e.g., frame members, housings, etc.) coupled to one another to form the chassis 20. The chassis 20 supports an enclosure, shown as cabin 22, that is configured to house one or more operators of the vehicle 10. The cabin may include one or more doors to facilitate access to the cabin 22.

The vehicle 10 further includes drivetrain or propulsion system, shown as a drivetrain 30, that is configured to propel the vehicle 10. The drivetrain 30 includes one or more tractive elements (e.g., wheel and tire assemblies, tracked assemblies, etc.), shown as wheels 32, rotatably coupled to the chassis 20. The wheels 32 are configured to engage a support surface (e.g., the ground) to support the vehicle 10. The vehicle 10 further includes one or more steering assemblies, shown as steering system 34, coupled to the chassis 20. The steering system 34 is configured to steer or otherwise control a direction of motion of the vehicle 10 (e.g., in response to a command from an operator of the vehicle 10). By way of example, the steering system 34 may include an actuator that pivots one or more of the wheels 32 relative to the chassis 20.

The drivetrain 30 includes one or more actuators, drive motors, or prime movers, shown as drive motors 36, coupled to the chassis 20. In some embodiments, the drive motors 36 include one or more electric motors (e.g., AC motors, DC motors, etc.). In some embodiments, the drive motors 36 include one or more internal combustion engines (e.g., gasoline engines, diesel engines, etc.). In some embodiments, the drive motors 36 include one or more internal combustion engines and one or more electric motors (e.g., forming a hybrid drivetrain). The drive motors 36 are configured to drive one or more of the wheels 32 to propel the vehicle 10. The drive motors 36 may be directly coupled to the wheels 32 and/or indirectly coupled to the wheels 32 (e.g., through a geared transmission, through a hydrostatic transmission, etc.).

The vehicle 10 further includes one or more energy storage devices (e.g., batteries, fuel tanks, etc.), shown as energy storage devices 40, coupled to the chassis 20. The energy storage devices 40 may store energy to power the systems of the vehicle 10 (e.g., the drive motors 36). The energy storage devices 40 may include batteries, fuel cells, fuel tanks, or other types of energy storage devices 40.

The vehicle 10 further includes an energy transfer interface, shown as charging interface 42, coupled to the chassis 20. The charging interface 42 is configured to transfer electrical energy into and/or out of the vehicle 10 (e.g., between the vehicle 10 and an electrical grid, a generator, etc.). For example, in some instances, the charging interface 42 is configured to receive electrical energy from an external source (e.g., a charging interface 4010 discussed below). The charging interface 42 may then supply this electrical energy to the energy storage devices 40 to charge the energy storage devices 40. In some embodiments, the charging interface 42 transfers energy wirelessly. In such embodiments, the charging interface 42 may include a wireless energy transfer coil to transfer energy through induction. In some embodiments, the charging interface 42 is configured to transfer electrical energy through a wired connection. In such embodiments, the charging interface 42 may include a set of electrical contacts positioned to engage a set of external electrical contacts. In other embodiments, the charging interface 42 is omitted.

The vehicle 10 further includes a control system 50 including a controller 52 that controls operation of the vehicle 10. The controller 52 includes a processing circuit, shown as processor 54, and a memory device, shown as memory 56. The memory 56 may contain one or more instructions that, when executed by the processor 54, cause the controller 52 to perform the processes described herein. While some processes may be described as being performed by the controller 52, it should be understood that those processes may be performed by any other controller of the system 100 or distributed across multiple controllers of the system 100. The controller 52 may control the drive motors 36 and the steering system 34 to navigate the vehicle 10. In some embodiments, the controller 52 navigates in response to commands from an operator. In some embodiments, the controller 52 navigates the vehicle 10 autonomously (e.g., without any directional control by an operator).

The control system 50 further includes a network interface, shown as communication interface 58, operatively coupled to the controller 52. The communication interface 58 is configured to transfer data between the vehicle 10 and other components of the system 100 (e.g., other vehicles 10, the user devices 102, the servers 104, the network 110, etc.). The communication interface 58 may facilitate wired and/or wireless communication.

The control system 50 further includes one or more sensors 60 operatively coupled to the controller 52. In some embodiments, the sensors 60 provide sensor data relating to the vehicle 10 (e.g., a current status of the vehicle 10). In some embodiments, the sensors 60 provide sensor data relating to the surroundings of the vehicle 10 (e.g., detecting nearby objects, etc.).

The control system 50 further includes a user interface or operator interface, shown as user interface 62, operatively coupled to the controller 52. The user interface 62 may include one or more output devices (e.g., display, speakers, haptic feedback devices, lights, projectors, etc.). In some embodiments, the user interface 62 includes one or more input devices (e.g., buttons, touch screens, microphones, etc.). The user interface 62 may extend within the cabin 22 to facilitate control over the vehicle 10 by an operator positioned within the cabin 22.

The vehicle 10 further includes one or more implement assemblies or end effectors, shown as implements 70. The implements 70 may be utilized by the vehicle 10 interact with the surrounding environment. By way of example, an implement 70 may include a lift assembly such as a boom or a scissor lift. By way of another example, an implement 70 may include lift forks or a grabber to engage or otherwise support an object from the surrounding environment.

The implements 70 may include one or more actuators, shown as implement actuators 72, that facilitate movement of the implements 70. By way of example, the implement actuators 72 may include rotary actuators, such as electric motors or hydraulic motors. By way of another example, the implement actuators 72 may include linear actuators such as hydraulic cylinders or electric linear actuators. The implement actuators 72 may be operatively coupled to the controller 52 to permit the controller 52 to control operation of the implements 70 by moving the implement actuators 72.

### Vehicle System

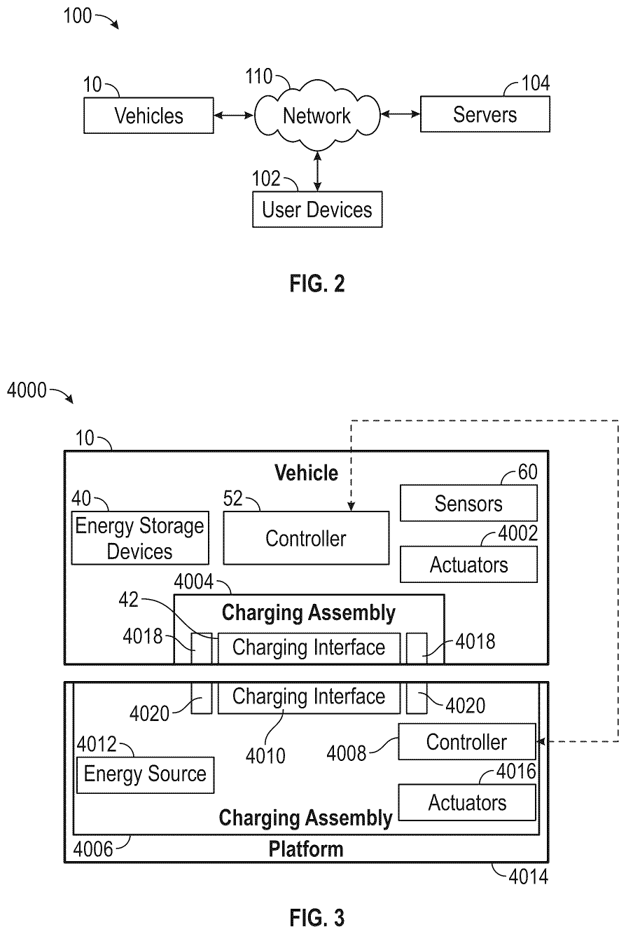

Referring to FIG. 2, the vehicle 10 is part of a vehicle system, work machine system, or jobsite system, shown as system 100, according to an exemplary embodiment. The system 100 may include one or more of the vehicles 10. As shown, the system 100 further includes one or more user interfaces or user devices (e.g., smartphones, tables, laptop computers, desktop computers, pagers, smart speakers, AI assistants, etc.), shown as user devices 102. The user devices 102 facilitate communication between one or more users and the system 100. By way of example, a user may provide a command, such as a command for the vehicle 10 to move to a specific location, through the user device 102. By way of another example, the system 100 may communicate the current location of a vehicle 10 to a user through the user devices 102.

The system 100 further includes one or more cloud devices, storage devices, databases, or vehicle managers, shown as servers 104 (e.g., cloud servers, cloud devices, cloud controllers, etc.). The servers 104 may store and/or process data to facilitate operation of the system 100. The servers 104 may store data and manage the flow of information throughout the system 100. By way of example, the servers 104 may track (e.g., retrieve and store) the current locations of the vehicles 10, the current statuses of the vehicles 10, information regarding authorized users of the system 100, or other information.

The components of the system 100 (e.g., the vehicles 10, the user devices 102, and/or the servers 104) may communicate with one another directly and/or across a network 110 (e.g., a cellular network, the Internet, etc.). In some embodiments, the components of the system 100 communicate wirelessly. By way of example, the system 100 may utilize a cellular network, Bluetooth, near field communication (NFC), infrared communication, radio, or other types of wireless communication. In other embodiments, the system 100 utilizes wired communication.

### Self-Aligning Wireless Charging Coil

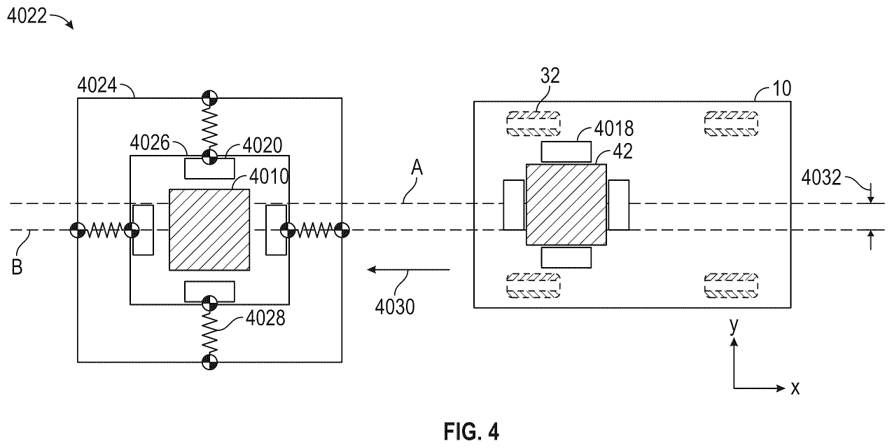

Referring now to FIG. 3-7, a wireless charging system 4000 is shown in which the charging interface 42 of the vehicle 10 and a charging interface 4010 on a platform 4014 are configured to align themselves using passive and/or active measures to ensure proper positioning of the charging interfaces 42 relative to the charging interface 4010. Because an efficiency of the wireless charging system 4000 and a strength of an induced current in an antenna coil in a charging assembly 4004 of the vehicle 10 depends on its position relative to an induction coil in a charging assembly 4006 of the platform 4014, accurate positioning may help to ensure a strong and stable induced current is generated/received by the induction coil and the antenna coil, respectively. In some examples, proper alignment allows for the use of a smaller coil to transmit the same level of power as compared to a system with more flexible alignment demands. In such a system without proper alignment, the coils must be enlarged and the magnetic field itself enlarged to ensure sufficient power is still being provided to the improperly aligned receiving antenna. By better aligning the charging coils, the size of the coils can be reduced, which in turn reduces the weight and cost of the platform 4014 and the vehicle 10.

Referring now to FIG. 3, a block diagram of the charging system 4000 is shown, according to one embodiment. The charging system 4000 includes the vehicle 10 and the platform 4014, which are in communication through their respective controllers (e.g., wired, wirelessly). The vehicle 10 includes the controller 52, as shown in FIG. 1. The controller 52 is operatively coupled to the energy storage devices 40. The controller 52 is also operatively coupled to sensors 60 and actuators 4002. The controller 52 is also operatively coupled to the charging assembly 4004. The charging assembly 4004 includes the charging interface 42. The platform 4014 includes the charging assembly 4006, which includes an energy source 4012, a controller 4008, a charging interface 4010, and actuators 4016. The energy source 4012 is configured to supply a current to the charging interface 4010. The charging interface 4010 is configured to transmit the current (e.g., via induction) to the charging interface 42. Accordingly, the current is configured to be received by the charging interface 42, which is then transmitted by the charging interface 42 to the energy storage device(s) 40.

The vehicle 10 may include one or more sensors 60. In some embodiments, the sensors 60 are coupled to the vehicle 10 and configured to initiate transfer of the energy by the charging assembly 4006 in response to detecting a presence of the vehicle 10 near the charging assembly 4006 (e.g., the presence of the charging interface 42 on the vehicle 10 near the charging interface 4010 on the platform). By way of example, the vehicle 10 is equipped with the one or more sensors 60 (e.g., a camera, voltage sensors, current sensors, temperature sensors, magnetic field sensors, etc.) in communication with the controller 52. The controller 52 receives feedback from the one or more sensors 60 and communicates to control a prime mover and/or a steering system of the vehicle 10. In some embodiments, the one or more sensors 60 include cameras to scan, periodically or continuously, for the platform 4014 and/or the charging assembly 4006. Upon detecting the platform 4014 and/or the charging assembly 4006, the controller 52 adjusts the position of the vehicle 10, using feedback from the one or more sensors 60, until the vehicle 10 is positioned in a desired relationship with the platform 4014 (e.g., the charging interface 42 is positioned in a desired relationship with the charging interface 4010).

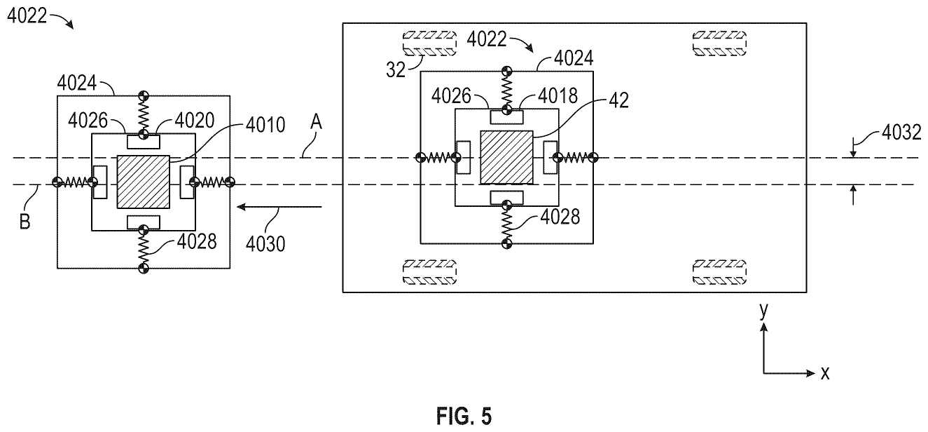

In some embodiments, the controller 52 detects via sensors 60 the charging interface 4010 through inference by measuring a voltage or current within the charging interface 42 that may be induced by the charging interface 4010. In some embodiments, the controller 52 detects via the sensors 60 the charging interface 4010 by detecting an increase in heat of the charging interface 42 indicative of a current being induced in the charging interface 42. In some embodiments, the sensors 60 include magnetic field sensors to sense one or more magnetic fields of the charging interface 4010 and the controller can determine a position of the charging interface 42 relative to the charging interface 4010 based on the detected magnetic fields. Once the appropriate positioning relative to the platform 4014 and/or the charging interface 4010 has been achieved and the vehicle 10 is correctly positioned above the charging interface 4010, the controller 52 can initiate a process to receive energy from the charging assembly 4006. In some embodiments, proper positioning of the charging interface 42 relative to the charging interface 4010 may be further facilitated by one or more spring assemblies 4022, as shown in FIG. 4-6. In some embodiments, proper positioning of the charging interface 42 relative to the charging interface 4010 may be further facilitated by one or more actuators, such as actuators 4002, actuators 4016, or both actuators 4002, 4016.

At least one of the charging interfaces 42, 4010 may be supported by one or more springs 4028, allowing the charging interface 42, 4010 to be biased to a first position but with the ability to be moved by stretching or compressing the one or more springs 4028. The charging assembly 4004 and the charging assembly 4006 may also each include a plurality of alignment members 4018 and 4020. In at least the embodiments depicted in FIGS. 3-6, the alignment members may be magnets, such as vehicle magnets 4018 and platform magnets 4020. The vehicle magnets 4018 and the platform magnets 4020 may be arranged in complementary patterns such that they attract each other in a specific position or orientation. In some embodiments, when the charging interface 42 of the vehicle 10 is generally aligned with the charging interface 4010 of the platform 4014 (e.g., +/−20% misalignment) the attractive force between the vehicle magnets 4018 and the platform magnets 4020 is great enough to overcome the spring force and move the moveable charging interrace 42, 4010 to substantially align the charging interfaces 42, 4010 by passive means. In some embodiments, the charging assembly 4006 further includes one or more actuators 4016 coupled to the charging interface 4010 to adjust a position of the charging interface 4010 based on signals from the controller 4008.

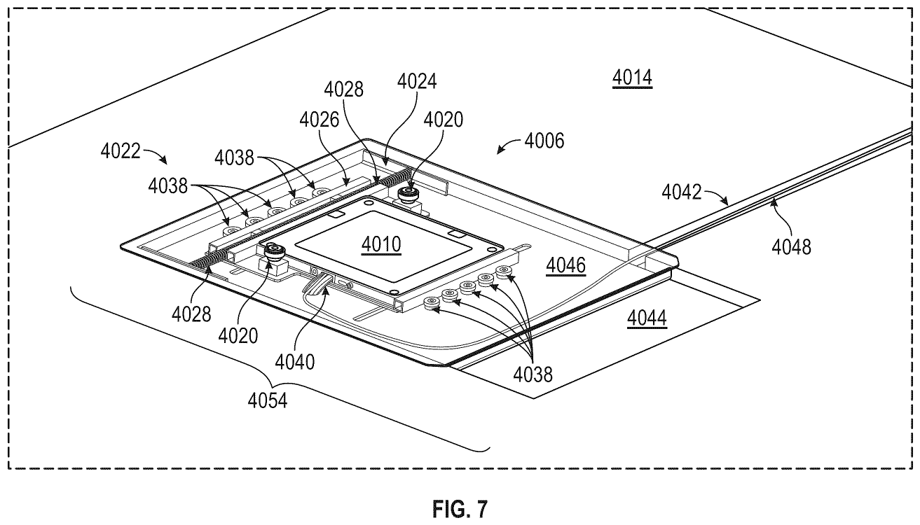

The vehicle 10 may include one or more actuators 4002. In some embodiments, the one or more actuators 4002 are coupled to the vehicle 10 (e.g., on the chassis 20) and can activate the charging process upon detection that the vehicle 10 is above the charging interface 4010. The one or more actuators 4002 may be mechanical actuators (e.g., levers, spring-biased inputs, pressors sensors, load sensors, etc.). The actuators 4002 can trigger the activation of the charging process. For example, when the vehicle 10 is in an ideal position for charging, the actuators 4002 will be actuated or otherwise activated, which indicates to the controller 52 to begin charging of the vehicle 10. In some embodiments, the actuators 4002 can be configured to further adjust the position of the vehicle 10 and/or the charging interface 42 so that the charging interface 42 and the charging interface 4010 are aligned. In some alternative embodiments, as shown in FIG. 6, the charging system 4000 may additionally comprise one or more actuators 4016 on at least one of charging interface 4010 or charging interface 42 to further align the charging interfaces 42, 4000 for proper positioning for charging. That is, the charging system 4000 may comprise one or more actuators 4016 on either the vehicle 10, the charging interface 4010, or both.

In some embodiments, a platform 4014 is positioned away from the vehicle 10. For example, the platform 4014 can be stationed fixedly to a location in a worksite. The charging assembly 4006 may be coupled to the platform 4014. In some embodiments, the charging assembly 4006 includes a controller 4008. The controller 4008 is operatively coupled to an energy source 4012. The energy source 4012 may be a utility source (e.g., from a wall socket, etc.), generator (e.g., a diesel generator or a natural gas generator, a fuel cell generator, etc.), a solar panel array, or battery assembly. The energy source 4012 is coupled to the charging interface 4010. In some embodiments, the charging interface 4010 includes an induction coil (e.g., a copper coil, etc.) that is configured to receive current from the energy source 4012. In some embodiments, the controller 4008 may communicate with the charging interface 4010 to initiate energy flow from the energy source 4012 to the charging interface 4010.

In some embodiments, the controller 52 may communicate with the controller 4008. For example, as the vehicle 10 approaches the platform 4014, the controller 52 may transmit a signal to the controller 4008. In some embodiments, the signal is communicated over a wireless network (e.g., NFC, Bluetooth, WiFi, cellular, etc.). In some embodiments, the signal is communicated via the charging interface 42 and charging interface 4010. For example, the controller 52 may control the charging interface 42 to induce a predetermined current or voltage in the charging interface 4010. The controller 4008 of the platform 4014 may include one or more sensors to monitor a current or voltage of the charging interface 4010 and detect the induced current or voltage, as the signal from the controller 52. The controller 4008, upon receiving the signal, may prompt the energy source 4012 to transmit energy to the charging interface 4010 to charge the vehicle. In response to receiving an indication that the vehicle 10 is near the charging interface 4010, the controller 4008 may execute a series of steps to begin the wireless charging process. For example, the controller 4008 may control a power source (e.g., the energy source 4012) to begin providing current to an induction coil within the charging interface 4010. In some examples, the actuators 4016 may act as a switch that closes a circuit to provide current to an induction coil in the charging interface 4010. In some embodiments, the controller 4008 may be omitted. In some embodiments, the controller 4008 monitors a position of the charging interface 4010, and in response to the position changing, for example when the vehicle magnets 4018 and the platform magnets 4020 align, may control the energy source 4012 to begin providing current to the charging interface 4010.

In some examples, the charging level of the vehicle 10 may be monitored. In some embodiments, the controller 52 can monitor a charging level of the vehicle 10. By way of example, the controller 52 can be configured to communicate with the energy storage devices 40 to monitor the charging level of the vehicle. In this example, when the controller 52 receives an indication that the vehicle 10 has finished charging, the controller 52 can execute a series of steps to terminate the wireless charging process. For example, in some embodiments, the controller 52 may send a notification to the controller 4008 of the charging assembly 4006 to cause the charging assembly 4006 to discontinue charging. In some embodiments, the controller 4008 can monitor the charging level of the vehicle 10.

Referring now to FIG. 4, a top view of the vehicle of FIG. 1 moving towards the charging interface 4010 is shown, according to one embodiment. As depicted in FIG. 4, the charging interface 42 and the charging interface 4010 may each be coupled to a plurality of magnets, shown as vehicle magnets 4018 and platform magnets 4020. For example, the charging interface 42 and the charging interface 4010 are each shown to be coupled to four magnets (e.g., the charging interface 42 is coupled to four vehicle magnets 4018, charging interface 4010 is coupled to four platform magnets 4020). In other embodiments, at least one of the charging interface 42 or the charging interface 4010 may include less or more vehicle magnets 4018 and platform magnets 4020. For example, the charging interface 4010 may include one large platform magnet 4020 surrounding the perimeter of the charging interface 4010.

During operation, the charging interface 42 may be roughly positioned by the user (via movement of the vehicle 10) over the charging interface 4010 (e.g., the vehicle 10 may be moved onto the platform 4014), or autonomously by the vehicle 10 itself. At this point, a distance between the vehicle magnets 4018 and the platform magnets 4020 may be small enough that the vehicle magnets 4018 can further align the charging interface 42 with the charging interface 4010, which may include the corresponding set of platform magnets 4020. In some embodiments, the vehicle 10 may align the charging interface 42 with the charging interface 4010 within a margin of error that is less than the distance required for the vehicle magnets 4018 and the platform magnets 4020 to align the charging interfaces 42, 4010. In some embodiments, the vehicle magnets 4018 and the platform magnets 4020 may be corresponding magnet pairs. The corresponding magnet pairs can be positioned with opposing poles facing each other to generate the attractive magnetic force 4036 between the corresponding magnets in a pairing. The vehicle magnets 4018 and platform magnets 4020 may be manufactured alignment magnet pairs that have stable preferred positions relative to one another. An alignment magnet may include multiple sections where the polarity differs between each section according to a pattern that is mirrored in the corresponding magnet. Specific arrangements of the polarities in an alignment magnet pair can result in a pair of magnets with a preferred positioning and orientation.

As the vehicle 10, including the charging interface 42, moves onto the platform 4014, the alignment magnets 4018 of the vehicle 10 and the alignment magnets 4020 of the charging interface 4010 can move into their preferred stable positioning which in turn can properly align the coils. The vehicle magnets 4018 and platform magnets 4020 may also include permanent magnets (neodymium ion boron, samarium cobalt, alnico, and ceramic/ferrite magnets), temporary magnets, electromagnets, or any combination thereof. For example, the charging interface 42 may include a set of permanent magnets 4018 while the charging interface 4010 may only include a set of temporary magnets 4020. For another example, when vehicle magnets 4018 and platform magnets 4020 are electromagnets, the vehicle magnets 4018 and platform magnets 4020 may be configured to be magnetized only during an initial alignment phase, for example when the vehicle 10 is first roughly positioned on the platform 4014, only during align and charging, etc. The vehicle magnets 4018 and platform magnets 4020 can then be magnetized and precisely align the charging interface 42 and the charging interface 4010. The positions of the charging interface 42 and the charging interface 4010 may then be secured (e.g., via a lock, wedge, or other securing mechanisms) and the vehicle magnets 4018 and platform magnets 4020 may then be demagnetized, which can ensure they do not interfere with the wireless charging.

In some examples, the charging interface 42 and the charging interface 4010 may additionally and/or alternatively use active positioning methods to ensure proper alignment. Active positioning can involve sensing one or more charging parameters and actively adjusting the position of the charging interfaces 42, 4010 until the parameter meets a desired level. For example, active positioning methods may include measuring the induced current generated by the charging interface 4010, charging interface 42, or both, and moving one or both of the charging interfaces 42, 4010 until the measured induced current is at a desired level (e.g., a local maximum level). Other measured parameters may be the strength of the magnetic field, the power draw, the data transfer rate, the power transfer rate, the temperature of the charging interface 42, 4010, etc.

For example, referring to FIG. 4, the charging interface 4010 may move along an x-axis or a y-axis based on the measured current produced by the charging interface 42 when positioned at least partially over the charging interface 4010. In some examples, this motion may be provided by one or more magnets, such as vehicle magnets 4018 or platform magnets 4020. In some examples, this motion may be provided by a combination of one or more magnets, such as vehicle magnets 4018 and platform magnets 4020, and one or more actuators, such as actuators 4002, 4016, as shown in FIG. 6, or merely by the one or more actuators 4002, 4016 on their own. In some examples, the charging interface 42 and/or the charging interface 4010 may be motorized to facilitate movement. Movement may also be achieved via a system of belts, pulleys, tracks, etc. In some embodiments, active alignment can include the wireless charging system 4000 assuming control over the movement of the vehicle 10 and using its tractive elements 32 to accurately position the charging interface 42 over the charging interface 4010 after being roughly positioned by an operator (e.g., human, autopilot system, etc.). Each of these active alignment systems can be used separately or in any combination to achieve active alignment.

In some embodiments, the charging interface 4010 is movably coupled to a spring assembly 4022. The spring assembly 4022 may include a fixed frame 4024 and a movable frame 4026. The fixed frame 4024 and the movable frame 4026 may be coupled by a plurality of spring elements 4028. In some embodiments, the spring assembly 4022 is arranged so that the charging interface 4010 remains in a central biased position relative to the fixed frame 4024 and the movable frame 4026. The spring assembly 4022 may be configured as to allow movement of the charging interface 4010 in order to align the charging interface 42 to the charging interface 4010. In some embodiments, the spring assembly 4022 is configured within the platform 4014 in a way such that the spring assembly 4022 and the charging interface 4010 are partially floating. Such a configuration allows for the spring assembly 4022 to adjust the position of the charging interface 4010 (e.g., to align with the charging interface 42).

Still referring to FIG. 4, the vehicle magnets 4018 and platform magnets 4020 are configured to initiate self-alignment between the charging interface 42 and the charging interface 4010. By way of example, as depicted in FIG. 4, the vehicle 10 is moving towards the platform 4014, as depicted by direction 4030. As the vehicle 10 approaches the platform 4014, there is a misalignment between the charging interface 42 on axis A and the charging interface 4010 on axis B, shown as misalignment 4032. To align the charging interface 42 to the charging interface 4010, the magnetic force between the vehicle magnets 4018 and platform magnets 4020 will move the charging interface 4010 to align the vehicle magnets 4018 and platform magnets 4020. In this embodiment, the spring elements 4028 will expand/contract to align the vehicle magnets 4018 and platform magnets 4020. When aligning the charging interfaces 42 and 4010, the magnetic force between the vehicle magnets 4018 and platform magnets 4020 can overcome the spring force in the spring assembly 4022. For example, the magnetic force can force the spring assembly 4022 out of the central biased position in order to properly align the charging interfaces 42, 4010.

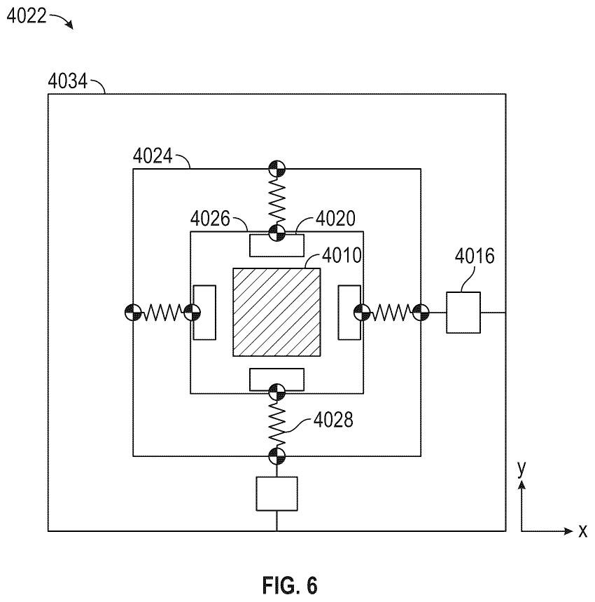

Referring now to FIG. 5, a top view of the vehicle 10 of FIG. 1 moving towards the second charging interface 4010 is shown, according to one embodiment. As shown in this embodiment, both the charging interface 42 and the charging interface 4010 may be movably coupled to spring assemblies 4022. In other alternative embodiments, charging interface 42 may be movably coupled to a spring assembly 4022 and charging interface 4010 may be fixed to the platform 4014 (e.g., the platform 4014 may not include a spring assembly 4022).

Referring now to FIG. 6, a top view of the charging interface 4010, including actuators 4016, is shown, according to one embodiment. In this embodiment, the charging interface 4010 includes actuators 4016 to optimize the position of the charging interface 4010 relative to the charging interface 42. In this embodiment, as shown in FIG. 6, the actuators 4016 may be coupled between the fixed frame 4024 and a second fixed frame 4034. In other embodiments, the actuators 4002 may be coupled to the spring assembly 4022 in an alternative arrangement. The actuators 4002 may further facilitate alignment between the charging interface 42 and the charging interface 4010.

In some embodiments, the charging system 4000 can additionally or alternatively include mechanisms for movement of the charging interface 4010 and/or the charging interface 42 in a vertical direction (a z-axis) to ensure they are positioned near enough for desired power transfer speeds. Ensuring the air gap between the charging interface 42 and the charging interface 4010 is not too large can vastly improve the proper and efficient functioning of the charging system 4000 and allow for reducing of the coil sizes, such as a coil size of an induction coil in the charging interface 4010 or an antenna coil in the charging interface 42 on the vehicle 10. In some examples where the vehicle 10 does not include the charging interface 42 in a permanent position that allows for the charging interface 42 to be positioned over the charging interface 4010 in properly alignment (such as in work machines which require extended ground clearance), the charging system 4000 can be configured to adjust the z-axis position of one or both of the charging interfaces 42, 4010 to ensure the proper air gap distance is reached. For example, in some instances, the vehicle 10 and/or the platform 4014 may include one or more actuators (e.g., electric actuators, hydraulic actuators, pneumatic actuators) configured to raise or lower the charging interface 42 and/or the charging interface 4010 to attain the proper air gap between the charging interface 42 and the charging interface 4010.

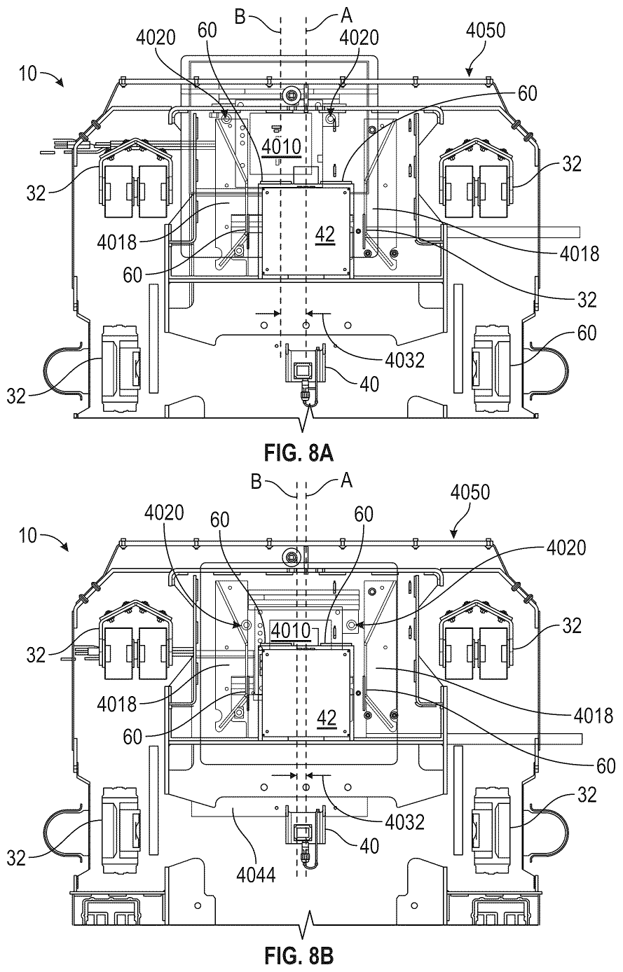

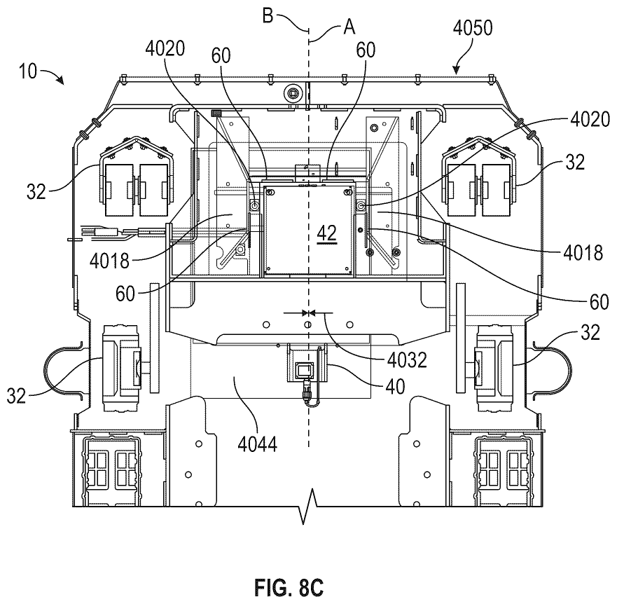

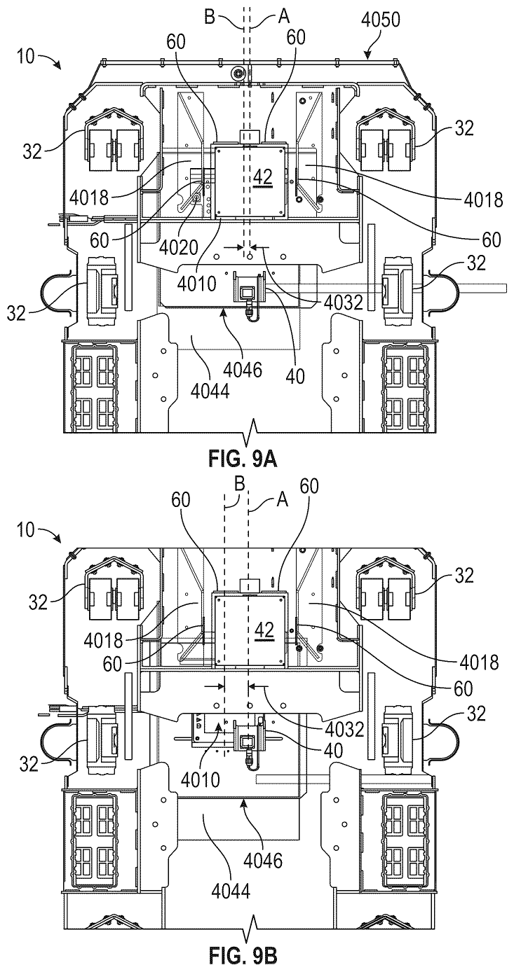

Referring now to FIG. 7, the charging assembly 4006 is depicted, according to one embodiment. In at least the embodiments shown in FIGS. 7-9, the charging assembly 4006 includes one or more alignment members 4020, such as one or more roller bearings 4020. The roller bearings 4020 may extend vertically or substantially vertically from a top surface of the charging assembly 4006. The roller bearings 4020 may be placed on opposite ends of the charging interface 4010. The roller bearings 4020 may be configured to contact one or more alignment members 4018 on the chassis 20 on the vehicle 10 to passively align the charging interfaces 42, 4010. Such a configuration is described further herein with respect to FIGS. 8A-9B.

The charging assembly 4006 may include a spring assembly 4022. For example, the spring assembly 4022 may include a fixed frame 4024 and a movable frame 4026 coupled by a plurality of spring elements 4028. As shown in FIG. 7, the charging assembly 4006 is disposed within a recess 4054 in the platform 4014. In such embodiments, the fixed frame 4024 may be walls of the platform 4014 defined by the recess 4054. In some embodiments, the spring assembly 4022 is arranged so that the charging interface 4010 remains in a central biased position relative to the fixed frame 4024 and the movable frame 4026. The spring assembly 4022 may be configured to allow movement of the charging interface 4010 in order to align the charging interfaces 42, 4010. For example, the spring assembly 4022 may allow the charging interface 4010 to move laterally to align with the charging interface 42. In some embodiments, the movable frame 4026 is a linear bearing that facilitates the lateral movement of the charging interface 4010. Additionally or alternatively, the movable frame 4026 may include a plurality of roller bearings 4038. For example, the roller bearings 4038 may be coupled to the movable frame 4026 and guide lateral movement of the movable frame 4026. In some embodiments, a second set of the roller bearings 4038 may be disposed on a second end of the charging interface 4010 opposite the first set of roller bearings 4038. The second set of roller bearings 4038 may ensure the proper movement of the charging interface 4010 on both ends of the charging interface 4010. Both sets of the roller bearings 4038 may also prevent the charging interface 4010 or other components of the charging assembly 4006 from moving forward or backward (e.g., longitudinally) with the vehicle 10. In some embodiments, the lateral movement of the charging interface 4010 provided by the spring assembly 4022 is responsive to a force produced by the contact between the roller bearings 4020 and the rail guides 4018. Such an interaction is described further herein with respect to FIGS. 8A-9B.

As previously mentioned, the charging assembly 4006 may be disposed at least partially within the platform 4014, in some embodiments. For example, FIG. 7 depicts the charging assembly 4006 disposed within a recess 4054 in the platform 4014. Installing the charging assembly 4006 in such a configuration provides a level surface between the platform 4014 and the charging assembly 4006, reducing the difficulty of a vehicle operator moving the vehicle 10 onto the correct area. The recess 4054 may vary in depth depending on the desired height of the charging assembly 4006 relative to the platform 4014. The depth of the recess 4054 may also depend on the size of the components of the charging assembly 4006. For example, installing the charging assembly 4006 in a hole in the platform 4014 that is around ¾ inch deep may provide a level surface between the charging assembly 4006 and the platform 4014 in the embodiments described herein.

In some embodiments, the platform 4014 may also include an additional recess, shown as the waste collection area 4044. The waste collection area is depicted in FIGS. 7-9. The waste collection area 4044 may be an area of the recess not occupied by the charging assembly 4006 or may be a separate recess. The waste collection area 4044 may be located next to an end of the charging assembly 4006 such that any debris under the vehicle 10 is caught by the waste collection area 4044 before the vehicle 10 moves onto the charging assembly 4006. In some embodiments, the platform 4014 may include multiple waste collection areas 4044, such that the vehicle 10 can move onto the charging assembly 4006 from any direction and waste can be effectively removed. In some embodiments, the vehicle 10 may include a sweeper 4050, shown in FIGS. 8 and 9. The sweeper 4050 may assist with debris collection by pushing the debris in the motion path of the vehicle 10 into the waste collection area 4044. Additionally, the sweeper 4050 may remove any debris present on the charging assembly 4006 as the vehicle 10 moves onto it. For example, the sweeper 4050 may be coupled to the front of the vehicle 10 and extend forward the vehicle 10. In this configuration, the sweeper 4050 pushes away the debris in an area before the vehicle 10 can reach said area. The sweeper 4050 shown in FIGS. 8 and 9 is coupled to the front of the vehicle 10, but it should be understood that the sweeper 4050 may be coupled to any area of the vehicle 10. For example, the sweeper 4050 may be coupled to the side(s) of the vehicle 10 or at the back end of the vehicle 10. Additionally, it should be understood that the vehicle 10 may include a plurality of sweepers 4050.

Referring back to FIG. 7, the platform 4014 may include a recessed path 4042. The recessed path 4042 may provide a path for a charging cable 4048. The charging cable 4048 may transmit power from the energy source 4012 to the charging assembly 4006. For example, the charging cable 4048 may be coupled to a wall socket and transmit the power from the wall socket to the charging interface 4010. The charging interface 4010 may include an outlet 4040 to receive the cable 4048. In addition to providing a path for the cable 4048, the recessed path 4042 eliminates the need for the cable 4048 to lay on the surface of the platform 4014. This configuration is beneficial because it reduces a risk of the vehicle 10 running over the cable 4048. Additionally, this configuration reduces the likelihood that the cable 4048 be a hazard for a person working on or near the platform.

In some embodiments, a cover 4046 may be coupled to at least part of the charging assembly 4006. Any one of the embodiments of the charging assembly 4006 described herein may include the cover 4046. For example, the embodiment shown in FIG. 7 depicts the cover 4046 over the recess which the charging assembly 4006 is disposed in. The cover 4046 may cover at least a portion of components of the charging assembly 4006, such as the spring assembly 4022 and the roller bearings 4038. In some embodiments, the cover 4046 may not cover at least a portion of components of the charging assembly 4006. For example, the charging interface 4010 may not be covered as to prevent obstruction of the charging process. Additionally, the roller bearings 4020 may not be covered, such that they are exposed and able to interact with the rail guide 4018 on the vehicle 10. The cover 4046 may be movably coupled to the charging assembly 4006. For example, the cover 4046 may be configured to move laterally together with the spring assembly 4022 or the charging interface 4010 when the charging interfaces 42, 4010 are aligned. Movement of the cover 4046 relative to the alignment process is described further herein with respect to at least FIGS. 9A-9B. In some embodiments, the cover 4046 may be translucent or transparent to provide clarity of operations of the components disposed beneath the cover 4046. In other embodiments, the cover 4046 may not be translucent or may be only partially translucent/transparent (e.g., a translucent window on the cover to show the spring assembly 4022).

Referring now to FIGS. 8A-8C, a top view of the vehicle 10 moving towards the charging assembly 4006 is shown, according to one embodiment. For example, the charging assembly 4006 shown in FIGS. 8A-8C may be the charging assembly 4006 of FIG. 7. In FIGS. 8A-8C, the dotted line A is shown to illustrate the center of the charging interface 42 on the vehicle 10. Similarly, the dotted line B is shown to illustrate the center of the charging interface 4010 on the platform 4014. The difference in position between the charging interfaces 42, 4010 (e.g., the distance between lines A and B) is depicted between the arrows depicting the misalignment 4032.

FIG. 8A depicts the vehicle 10 and components the charging assembly 4004 as the vehicle 10 is guided onto the platform 4014. As shown, the vehicle 10 may control its wheels 32 to move forward onto the platform 4014 and approach the charging assembly 4006. As the wheels 32 move the vehicle 10 towards the charging assembly 4006, the charging interfaces 42, 4010 may not be aligned, which can be visualized by the misalignment 4032.

In order to passively align the charging interfaces 42, 4010 as the vehicle 10 moves forward, the roller bearings 4020 (e.g., the alignment members on the platform 4014) may engage the rail guides 4018 (e.g., the alignment members on the vehicle 10). In the example shown in FIG. 8A, the misalignment 4032 is due to the charging interface 42 being too far left relative to the charging interface 4010. In this event, the left guide of the rail guides 4018 contacts a roller bearing 4020 that is left of the charging interface 4010. As the vehicle 10 continues to move forward, the roller bearing 4020 will maintain contact with the rail guide 4018, which creates a contact force that forces the roller bearing 4020 and additional components of the charging assembly 4006 to move laterally to the right. For example, such contact force may cause the springs 4028 to compress in the direction of the vehicle 10 in attempt to move the charging interface 4010 to the lateral position of the charging interface 42. Such spring force, together with the lateral movement facilitated by the roller bearings 4038, facilitate the lateral movement of the charging assembly 4006.

As shown in FIG. 8B, as the vehicle 10 moves forward and the roller bearing 4020 maintains contact with the rail guide 4018, the misalignment 4032 between the charging interfaces 41, 4010 decreases. The misalignment 4032 is even further reduced at the position shown in FIG. 8C, as both of the roller bearings 4020 contact the guide rails 4018 at an aligned position. At this position, the charging process may be initiated. For example, the charging interface 42 may collect power from the charging interface 4010. For example, the charging interface 4010 may receive energy from the energy source 4012 and generate an attractive magnetic field 4036 between the charging interfaces 42, 4010. The charging interface 42 may collect the energy generated by the attractive magnetic field 4036 and store the energy in an energy storage device 40 on the vehicle. The sensors 60 that detect the proper positioning of the charging interfaces 42, 4010 are also shown.

FIGS. 9A-9B depict the vehicle 10 moving away from the charging assembly 4006, for instance once the vehicle 10 has finished charging. The vehicle 10 may control its wheels 32 move forward on the platform 4014 and away from the charging assembly 4006. Meanwhile, one of the roller bearings 4020 may maintain contact with one of the guide rails 4018 to misalign the charging interfaces 42, 4010. For example, FIG. 9A illustrates contact between the left roller bearing 4020 and the left guide rail 4018. This contact forces the charging assembly 4006 to move left as the roller bearing 4020 moves down the guide rail 4018, resulting in the misalignment 4032. As the vehicle 10 moves further away from the charging assembly 4006, the contact force between the roller bearing 4020 and the rail guide 4018 further pushes the charging assembly 4006 to the left. For example, FIG. 9B shows the vehicle 10 as it is almost completely moved off the charging assembly 4006, and the misalignment 4032 is increased relative to the misalignment 4032 in FIG. 9A. Therefore, a positive relationship between misalignment and distance between the charging interfaces 42, 4010 is established (e.g., misalignment reduces as the vehicle 10 moves closer to the charging assembly 4006, and similarly misalignment increases as the vehicle 10 moves further away from the charging assembly 4006). The change in alignment depicted by FIGS. 9A-9B also serve to convey that the alignment process can be performed for a vehicle 10 moving backwards onto the platform 4014. For example, FIG. 9B may represent the vehicle 10 beginning to back onto the charging assembly 4006, and FIG. 9A may represent the vehicle 10 as it is close to proper alignment. Ultimately, when the charging assembly 4006 is not required to align the charging interfaces 42, 4010, the charging assembly 4006 should be center-biased relative to the recess. Therefore, as the vehicle 10 moves off of the charging assembly 4006, the charging assembly 4006 gradually returns to the center-biased position.

FIGS. 8A-9B also depict movement of the cover 4046 as the charging assembly 4006 moves to align the charging interfaces 42, 4010. Such movement can be seen most clearly in FIGS. 9A-9B. As the vehicle 10 begins to move away from the charging assembly 4006, the misalignment 4032 is the smallest (e.g., relative to the misalignment in FIG. 9B). At this position, the cover 4046 is shown to be shifted to the right, which is towards the direction that the charging interface 4010 was moved to align the charging interfaces 42, 4010. Next, as the misalignment 4032 increases, as shown in FIG. 9B, the cover 4046 moves back towards a centered position over the recess 4054. In sum, as the cover 4046 shifts, the charging interface 4010 is similarly shifted, which aligns the charging interfaces 42, 4010. Therefore, if the charging assembly 4006 has to overcome a large misalignment 4032, the cover 4046 will be significantly shifted when the charging interfaces 42, 4010 are aligned.

The embodiments as shown and described in FIGS. 7-9 depict a configuration in which the charging assembly 4006 on the platform 4014 is movable in order to align the charging interfaces 42, 4010. However, it should be understood that the charging assembly 4004 on the vehicle 10 may be movable and the charging assembly 4006 on the platform 4014 may maintain a fixed position. For example, the roller bearings 4020 may be disposed on the vehicle, and the guide rails 4018 may be disposed on the platform 4014. In this instance, the contact force created between the roller bearings 4020 and the guide rails 4018 may force the charging assembly 4004 on the vehicle to shift. Further, in some embodiments, both the charging assembly 4004 and the charging assembly 4006 may be movable. Additionally, it should be understood that any features of the charging system 4000 as described in FIGS. 7-9 are not limited to only the embodiments for which they were described. For example, the charging system 4000 shown in FIG. 4 may include roller bearings 4018 and/or guide rails 4020. As another example, the charging system 4000 shown in FIG. 7 may include one or more magnets 4018, 4020.

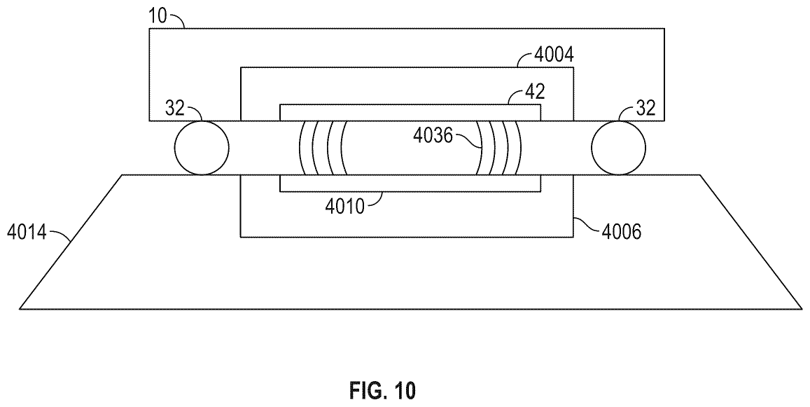

Referring now to FIG. 10, a perspective view of the charging interface 42 on the vehicle 10 of FIG. 1 aligned with the charging interface 4010 on the platform 4014 is shown, according to some embodiments. For example, FIG. 10 may be a perspective view of any of the embodiments of the charging system 4000 shown and described herein. As shown in FIG. 10, the charging assembly 4006, which includes the charging interface 4010, is received within the platform 4014 and positioned near an upper surface of the platform 4014. In some embodiments, an induction coil in the charging interface 4010 is configured to receive electricity from the energy source 4012 and generate a magnetic field 4036 that extends upwardly, through the upper surface of the platform 4014. In some embodiments, the charging interface 42 is received within the chassis 20 of the vehicle 10. The platform 4014 is configured to allow the vehicle 10 to move to roughly position the charging interface 42 over the charging interface 4010. The charging system 4000 may then properly align the charging interfaces 42, 4010. In some embodiments, an antenna coil in the charging interface 42 is configured to receive the magnetic field 4036 and transmit the energy to the energy storage device 40.

In some embodiments, the charging interface 4010 is configured to be partially floating within the platform 4014. By way of example, the fixed frame 4024 may be fixedly coupled to the platform 4014 to allow the alignment members to freely move, thereby allowing for movement of the charging interface 4010. In some embodiments, the fixed frame 4024 is defined by walls of a recess 4054 defined within the platform 4014. The partially floating positioning of the charging interface 4010 on the platform 4014 provides freedom of movement of the charging interface 4010 (e.g., allows translation or rotation) to properly align the charging interfaces 42, 4010. In this embodiment, the movable charging interface 4010 is received within the platform 4014. Configuration of the movable charging interface 4010 being on the ground or on the platform 4014 is advantageous, as the platform 4014 can be easily configured to allow space for the spring assembly 4022. However, in some other embodiments, at least one or both of charging interfaces 42, 4010 may be configured to be movable.

In some embodiments, alignment of the charging interface 42 relative to the charging interface 4010 can be determined by one or more secondary effects or characteristics indicative of charging or charging efficiency. That is, upon navigation to the platform 4014 and alignment of the self-aligning wireless charger coils, the controller 52 may measure one or more items related to the charging process and indicative of its efficiency to determine the alignment of the charging interfaces 42, 4010. By way of example, upon initiation of the charging process, the controller 52 may prompt the sensors 60 to measure a current being transferred through a charging coil. In some instances, the controller 52 can store a value that corresponds to a maximized or expected current level (e.g., the maximum or expected energy transfer when perfect or intended alignment is present). Based on the sensor data, the controller 52 can move the vehicle 10 to reposition the charging interface 42 until this stored current level is met. In some instances, the controller 52 may be configured to move the vehicle 10 while continuously monitoring the current being transferred to find, in real-time, a position where the maximum local current transfer occurs (and thus the charging interfaces are in the closest alignment). In some embodiments, the charging interface 42 can be repositioned using the actuators 4002. In some embodiments, the charging interface 4010 can be repositioned using the actuators 4016.

As another example, upon initiation of the charging process, the controller 52 may prompt the sensors 60 to measure a heat generated by inductive energy transfer. In some instances, the controller 52 can store a value that corresponds to a maximized or expected heat generation level (e.g., the maximized or expected inductive energy transfer when perfect or intended alignment is present). Based on the sensor data, the controller 52 can move the vehicle 10 to reposition the charging interface 42 until the maximized heat level is met. Similarly, in some instances, the controller 52 may be configured to move the vehicle 10 while continuously monitoring the heat generated to find, in real-time, a position where a maximum heath generation level occurs (and thus the charging interfaces are in the closest alignment). In some embodiments, the charging interface 42 can be repositioned using the actuators 4002. In some embodiments, the charging interface 4010 can be repositioned using the actuators 4016.

### SLAM and Secondary Effects

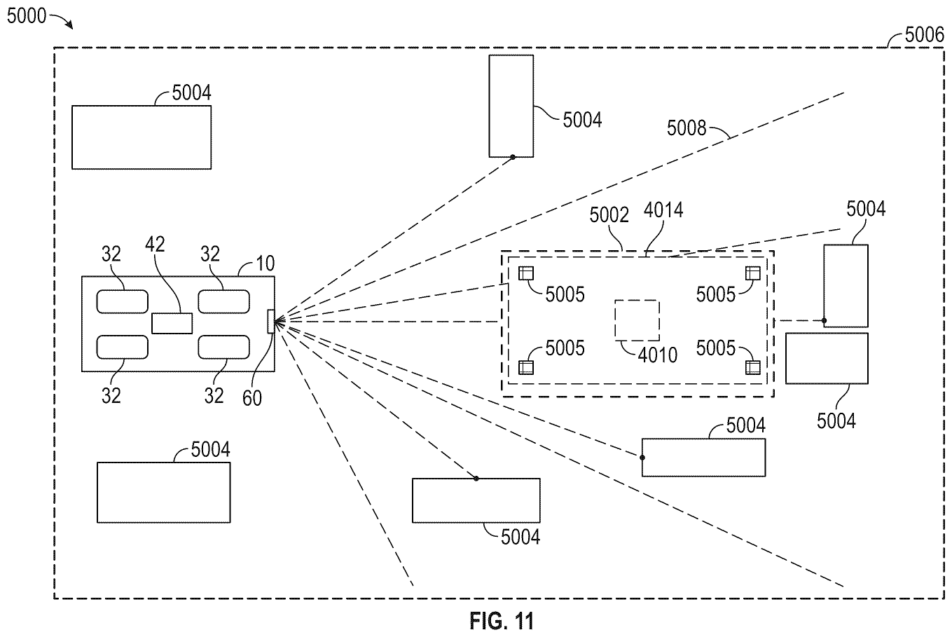

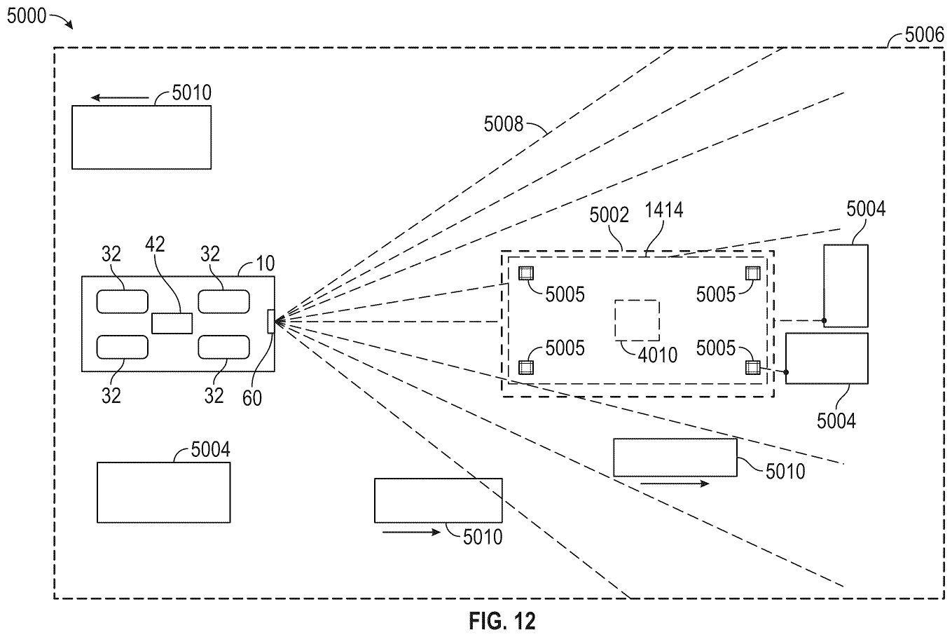

Referring now to FIGS. 11-12, at least one embodiment relates to a charging system 5000 including a vehicle 10 and a charging station 5002. The charging station 5002 includes a platform 4014, which includes an induction coil configured to receive electricity from an energy source and generate a magnetic field that extends upwardly, through the upper surface of the platform 4014 within the charging station 5002. The vehicle 10 includes sensors 60 (such as LIDAR sensors) for simultaneous localization and mapping (SLAM) of environmental features 5004 surrounding the charging station 5002. Utilization of SLAM can be beneficial for autonomous vehicle navigation such that it can provide enhanced obstacle avoidance when navigating a vehicle to a desired location. One specific benefit of SLAM for autonomous vehicle navigation is that it can ensure navigation under non-ideal conditions. For example, if the vehicle loses traction (e.g., the vehicle drives over an oil spill and its wheels lose traction), the vehicle 10 can still be accurately navigated towards the charging station 5002, as the navigation is based on the vehicle's surroundings rather than based on an alternative measure, such as wheel spin.

Still referring to FIGS. 11-12, the worksite may contain a charging station area 5002. In some embodiments, the charging station area 5002 represents the platform 4014. In other embodiments, the charging station area 5002 may include the platform 4014 and additional area surrounding the platform 4014. By way of example, the charging station area 5002 may begin one foot in front of the platform 4014.

The controller 52 of the vehicle 10 may be equipped to perform a Simultaneous Localization and Mapping (SLAM) algorithm. The SLAM algorithm can be configured to receive sensor data from the sensors 60 as an input. The sensors 60 may include LIDAR sensors, cameras, a combination of LIDAR sensors and/or cameras, and/or any other sensor configuration optimal for SLAM. As the vehicle 10, including the sensors 60, moves around an environment/worksite 5006, the sensors 60 simultaneously feed the SLAM algorithm sensor data. The SLAM algorithm is configured to receive the sensor data and construct a 3-dimensional mapping of the environment 5006. The SLAM algorithm is configured to match the features of environmental objects 5004 between sets of sensor data. By way of example, a first set of sensor data can be sent to the SLAM algorithm, wherein the SLAM algorithm may identify four corners of a given environmental object 5004. As the vehicle 10 moves relative to said environmental object 5004, a second set of sensor data can then be sent to the SLAM algorithm. Using a feature matching technique, the SLAM algorithm can determine, for example, four corners of the environmental object 5004 and thereby determine that it is the same object (e.g., a landmark). This process can also allow the controller 52 to determine the distance that the vehicle 10 has moved between subsequent sensor data collections. The SLAM algorithm will continue the process until there is a definite mapping of all environmental features 5004 in the area.

Referring now to FIG. 11, a top view of the vehicle of FIG. 1 aligning with the charging station area 5002 using SLAM, according to an exemplary embodiment. The vehicle 10 may be equipped with sensors 60. The sensors 60 can be Light Detection and Ranging (LIDAR) sensors. As the vehicle 10 drives towards the charging station area 5002, the LIDAR sensors(s) 60 transmit a plurality of signals (e.g., LIDAR signal), shown as signals 5008, away from the vehicle 10 to the surrounding environment 5006. The LIDAR sensor(s) 60 are configured to receive the signals 5008 back to acquire vision data regarding detected objects 5004. The vision data can then be sent to the controller 52 to perform the SLAM process. The LIDAR sensor(s) 60 will continue to collect and transmit vision data to the controller 52 to map the environment as the vehicle 10 moves. In some other embodiments, the sensors 60 may be different types of sensors compatible with the SLAM algorithm (e.g., a camera).

Referring now to FIG. 12, a top view of the vehicle 10 of FIG. 1 aligning with the charging station area 5002 using SLAM, according to an exemplary embodiment. To continue with the previous example, the vehicle 10 is equipped with LIDAR sensors 60 that transmit vision data to the controller 52 to perform the SLAM process. Based on the vision data, the controller 52 is configured to detect moving objects 5010 and non-moving objects 5004 and filter out the moving objects 5010. For the moving objects 5010, based on the simultaneous output of the SLAM process, the controller 52 can be configured to detect and track movements of the moving objects 5010 and characteristics thereof including a speed relative to the vehicle 10, a heading relative to the vehicle 10, a relative distance to the vehicle 10, a path of travel, a size, a type of object, and/or other characteristics. Based on these characteristics, the controller 52 may be configured to distinguish between moving objects 5010 (e.g., other vehicles, people in the work environment, etc.) and non-moving objects 5004. The objects that are determined to be non-moving objects can then be mapped as an environmental feature 5004. In other embodiments, the SLAM process may treat both moving objects 5010 and non-moving objects 5004 in the same manner.

In some embodiments, the charging station area 5002 can be configured in such a way that it is easily identifiable by the SLAM algorithm. For example, the charging station area 5002 may be configured to have a unique shape (e.g., rounded edges, raised above the ground, etc.) which may assist detection of the charging station area 5002 in the SLAM process. In some embodiments, where the sensors 60 are cameras, the charging station area 5002 may include unique features that can be detected by the camera. For example, the perimeter of the charging station area 5002 may be lined with a reflective material or lights, which can be detected by the camera. In this embodiment, the configuration of the charging station area 5002 with unique features and utilization of the SLAM process work together to enhance autonomous navigation of the vehicle 10. In some alternative embodiments, including these features on the charging station area 5002 may replace the need for SLAM on the other features in the environment. In some embodiments, the charging area 5002 may include one or more markers or visual indicia detectable by the sensors 60 to be used for the SLAM navigation that uniquely identify the charging station area 5002.

In some embodiments, the charging station area 5002 includes one or more artificial landmarks for the SLAM navigation, shown as landmarks 5005. The landmarks 5005 allow a vehicle 10 not only to navigate to the charging station area 5002 but to navigate with enough precision to align a charging interface of the vehicle 10 (e.g., charging interface 42) with a charging interface of the platform 4014 (e.g., charging interface 4010). The landmarks 5005 may all be the same or one or more landmarks 5005 may have one or more different characteristics such as shape, color, size, position, reflectivity, etc. to assist with SLAM navigation.

In some embodiments, the vehicle 10 can be properly positioned on the charging station 5002 with both the SLAM process and by using the self-aligning wireless charger coils described above, with respect to the charging system 4000. By way of example, the vehicle 10 can be autonomously navigated to the charging station area 5002 using the SLAM process. Once the vehicle 10 is within the charging station area 5002, the charging interface 42 of the vehicle 10 and the charging interface 4010 within the charging station area 5002 are within the required distance to initiate self-aligning with the charging assemblies 4004, 4006 (e.g., by passive alignment provided by the alignment members 4018, 4020 and the spring assemblies 4022). For example, when the charging system 4000 utilizes vehicle magnets 4018 and charging magnets 4020 (e.g., as shown in the embodiments illustrated in FIGS. 4-6), the charging interface 42 is guided to a distance relative to the charging interface 4010 such that the magnetic force between the vehicle magnets 4018 and the platform magnets 4020 becomes present.

In some embodiments, alignment of the charging interface 42 relative to the charging interface 4010 can be determined by one or more secondary effects or characteristics indicative of charging or charging efficiency. That is, upon navigation to the charging station area 5002 by the SLAM process and/or the self-aligning wireless charger coils, the controller 52 may measure one or more items related to the charging process and indicative of its efficiency to determine the alignment of the charging interfaces 42, 4010. By way of example, upon initiation of the charging process, the controller 52 may prompt the sensors 60 to measure a current being transferred through a charging coil. In some instances, the controller 52 can store a value that corresponds to a maximized or expected current level (e.g., the maximum or expected energy transfer when perfect or intended alignment is present). Based on the sensor data, the controller 52 can move the vehicle 10 to reposition the charging interface 42 until this stored current level is met. In some instances, the controller 52 may be configured to move the vehicle 10 while continuously monitoring the current being transferred to find, in real-time, a position where the maximum local current transfer occurs (and thus the charging interfaces are in the closest alignment). In some embodiments, the charging interface 42 can be repositioned using the actuators 4002. In some embodiments, the charging interface 4010 can be repositioned using the actuators 4016.

As another example, upon initiation of the charging process, the controller 52 may prompt the sensors 60 to measure a heat generated by inductive energy transfer. In some instances, the controller 52 can store a value that corresponds to a maximized or expected heat generation level (e.g., the maximized or expected inductive energy transfer when perfect or intended alignment is present). Based on the sensor data, the controller 52 can move the vehicle 10 to reposition the charging interface 42 until the maximized heat level is met. Similarly, in some instances, the controller 52 may be configured to move the vehicle 10 while continuously monitoring the heat generated to find, in real-time, a position where a maximum heath generation level occurs (and thus the charging interfaces are in the closest alignment). In some embodiments, the charging interface 42 can be repositioned using the actuators 4002. In some embodiments, the charging interface 4010 can be repositioned using the actuators 4016.

While the alignment members and environmental feature detection techniques shown and described herein are utilized to align a charging apparatus of the vehicle with a charging apparatus of the platform, it should be appreciated that, in some embodiments, the alignment members and/or the environmental feature detection techniques may be utilized to align a variety of other features of the vehicle with corresponding features of the platform or another type of vehicle-related station. For example, the alignment members and environmental feature techniques can be utilized to align a communication port on a vehicle with a communication port on a platform (e.g., for diagnostics, updates, real-time monitoring, or other communication measures), as well as aligning refueling connections or any other interfaces or components between the vehicle and the platform. Additionally or alternatively, the self-navigation and self-alignment features described herein may be used to assist with autonomous vehicle docking, vehicle maintenance, or other functionalities between the vehicle and the platform.

As utilized herein with respect to numerical ranges, the terms “approximately,” “about,” “substantially,” and similar terms generally mean +/−10% of the disclosed values. When the terms “approximately,” “about,” “substantially,” and similar terms are applied to a structural feature (e.g., to describe its shape, size, orientation, direction, etc.), these terms are meant to cover minor variations in structure that may result from, for example, the manufacturing or assembly process and are intended to have a broad meaning in harmony with the common and accepted usage by those of ordinary skill in the art to which the subject matter of this disclosure pertains. Accordingly, these terms should be interpreted as indicating that insubstantial or inconsequential modifications or alterations of the subject matter described and claimed are considered to be within the scope of the disclosure as recited in the appended claims.

It should be noted that the term “exemplary” and variations thereof, as used herein to describe various embodiments, are intended to indicate that such embodiments are possible examples, representations, or illustrations of possible embodiments (and such terms are not intended to connote that such embodiments are necessarily extraordinary or superlative examples).

The term “coupled” and variations thereof, as used herein, means the joining of two members directly or indirectly to one another. Such joining may be stationary (e.g., permanent or fixed) or moveable (e.g., removable or releasable). Such joining may be achieved with the two members coupled directly to each other, with the two members coupled to each other using a separate intervening member and any additional intermediate members coupled with one another, or with the two members coupled to each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

References herein to the positions of elements (e.g., “top,” “bottom,” “above,” “below”) are merely used to describe the orientation of various elements in the FIGURES. It should be noted that the orientation of various elements may differ according to other exemplary embodiments, and that such variations are intended to be encompassed by the present disclosure.

The hardware and data processing components used to implement the various processes, operations, illustrative logics, logical blocks, modules and circuits described in connection with the embodiments disclosed herein may be implemented or performed with a general purpose single- or multi-chip processor, a digital signal processor (DSP), an application specific integrated circuit (ASIC), a field programmable gate array (FPGA), or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some embodiments, particular processes and methods may be performed by circuitry that is specific to a given function. The memory (e.g., memory, memory unit, storage device) may include one or more devices (e.g., RAM, ROM, Flash memory, hard disk storage) for storing data and/or computer code for completing or facilitating the various processes, layers and modules described in the present disclosure. The memory may be or include volatile memory or non-volatile memory, and may include database components, object code components, script components, or any other type of information structure for supporting the various activities and information structures described in the present disclosure. According to an exemplary embodiment, the memory is communicably connected to the processor via a processing circuit and includes computer code for executing (e.g., by the processing circuit or the processor) the one or more processes described herein.

The present disclosure contemplates methods, systems and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general purpose computer, special purpose computer, or special purpose processing machines to perform a certain function or group of functions.

Although the figures and description may illustrate a specific order of method steps, the order of such steps may differ from what is depicted and described, unless specified differently above. Also, two or more steps may be performed concurrently or with partial concurrence, unless specified differently above. Such variation may depend, for example, on the software and hardware systems chosen and on designer choice. All such variations are within the scope of the disclosure. Likewise, software implementations of the described methods could be accomplished with standard programming techniques with rule-based logic and other logic to accomplish the various connection steps, processing steps, comparison steps, and decision steps.

It is important to note that the construction and arrangement of the system as shown in the various exemplary embodiments is illustrative only. Additionally, any element disclosed in one embodiment may be incorporated or utilized with any other embodiment disclosed herein. For example, the spring assembly of the exemplary embodiment shown in at least FIG. 4 may be incorporated in the charging station of the exemplary embodiment shown in at least FIG. 10. Although only one example of an element from one embodiment that can be incorporated or utilized in another embodiment has been described above, it should be appreciated that other elements of the various embodiments may be incorporated or utilized with any of the other embodiments disclosed herein.

What is claimed is:

1. A platform for charging a vehicle, comprising:
a charging apparatus including:
an energy source;
a first charging interface operatively coupled to the energy source and configured to wirelessly transmit energy to an energy storage device of the vehicle via a second charging interface of the vehicle; and
a first plurality of alignment members configured to interact with a second plurality of alignment members on the vehicle to align the first charging interface relative to the second charging interface.

2. The platform of claim 1, wherein the first plurality of alignment members and the second plurality of alignment members are magnets.

3. The platform of claim 1, wherein the first plurality of alignment members is a first plurality of roller bearings extending vertically from a top surface of the platform, and the second plurality of alignment members is a plurality of rail guides coupled to an underside of the vehicle.

4. The platform of claim 3, wherein the first charging interface further comprises a second plurality of roller bearings coupled to a spring assembly, wherein the second plurality of roller bearings facilitates lateral movement of the first charging interface and restricts longitudinal movement of the first charging interface.

5. The platform of claim 4, wherein the spring assembly comprises a plurality of springs coupled to a fixed frame and a movable frame.

6. The platform of claim 1, further comprising one or more actuators to further facilitate alignment between the first charging interface and the second charging interface.

7. The platform of claim 1, further comprising an induction coil configured to receive the energy from the energy source and generate a magnetic field above an upper surface of the first charging interface to wirelessly transfer the energy to the vehicle.

8. The platform of claim 7, wherein the charging apparatus further comprises a sensor and is configured to initiate generation of the magnetic field by the induction coil in response to detecting, via the sensor, a presence of the vehicle on the platform.

9. The platform of claim 1, further comprising a recess in the platform and in front of the charging apparatus configured to collect debris swept by a sweeper coupled to the vehicle as the vehicle moves to align with the first charging interface to prevent the debris from moving onto the first charging interface.

10. The platform of claim 9, wherein the charging apparatus is housed at least partially within a recess in the platform and at least a portion of the charging apparatus is enclosed in the recess by a cover.

11. A charging system, comprising:
a vehicle, comprising:
an energy storage device; and
a first charging apparatus, comprising:
a first charging interface operatively coupled to the energy storage device configured to wirelessly receive energy from an energy source; and
a first plurality of magnets;
a platform, comprising:
a second charging apparatus comprising:
the energy source;
a second charging interface operatively coupled to the energy source configured to transmit energy to the energy storage device; and
a second plurality of magnets;
wherein at least one of the first charging apparatus or the second charging apparatus includes a spring assembly configured to allow an attraction force between the first plurality of magnets and the second plurality of magnets to align the first charging interface relative the second charging interface.

12. The charging system of claim 11, further comprising one or more actuators coupled to the spring assembly, wherein the one or more actuators further facilitate alignment between the first charging interface and the second charging interface.

13. The charging system of claim 11, wherein the vehicle further comprises a controller to control a transfer of the energy from the energy source to the energy storage device, wherein the controller is configured to:
determine a secondary effect indicative of a charging efficiency; and
control the vehicle to align the first charging interface with the second charging interface based on the secondary effect indicative of the charging efficiency.

14. The charging system of claim 13, wherein the secondary effect indicative of the charging efficiency is at least one of a level of current transferred through a charging coil of at least one of the first charging apparatus or the second charging apparatus or a level of heat generated by inductive energy transfer.

15. The charging system of claim 11, further comprising:
a sweeper coupled to a front end of the vehicle; and
a recess in the platform and in front of the second charging apparatus, wherein the sweeper is configured to collect debris as the vehicle moves to align the first charging interface with the second charging interface, and the recess collects the debris as or before the vehicle moves the first charging interface into alignment with the second charging interface.

16. A charging system, comprising:
a vehicle, comprising:
an energy storage device; and
a first charging apparatus, comprising:
a first charging interface operatively coupled to the energy storage device configured to wirelessly receive energy from an energy source; and
a guide fixedly coupled to an underside of the vehicle;
a platform, comprising:
a second charging apparatus comprising:
the energy source;
a second charging interface operatively coupled to the energy source configured to transmit energy to the energy storage device; and
a first plurality of roller bearings projecting vertically from a top surface of the platform;
wherein the first plurality of roller bearings is configured to engage the guide as the vehicle moves onto the platform to align the first charging interface relative to the second charging interface.

17. The charging system of claim 16, further comprising a spring assembly comprising a plurality of springs coupled to opposite ends of the second charging apparatus, wherein the second charging interface is movably coupled to the spring assembly.

18. The charging system of claim 16, further comprising a second plurality of roller bearings configured to facilitate lateral movement of the second charging apparatus and restrict longitudinal movement of the second charging interface.

19. The charging system of claim 17, wherein the first plurality of roller bearings push against the guide, causing the spring assembly to move the second charging interface in a direction that the first plurality of roller bearings were pushed.

20. The charging system of claim 16, further comprising:
a sweeper coupled to a front end of the vehicle; and
a recess in the platform and in front of the second charging apparatus, wherein the sweeper is configured to collect debris as the vehicle moves to align the first charging interface with the second charging interface, and the recess collects the debris before the vehicle moves onto the second charging apparatus.
